(19) United States
(12) Patent Application Publication
(10) Pub. No.: US 2002/0128948 A1
(43) Pub. Date: Sep. 12, 2002

(54) Interactive offer system bidder status management system and method

(75) Inventors: Leland James Wiesehuegel, Austin, TX (US); Rebecca Lynn Roberts, Austin, TX (US); William James Morrison, Gilmanton, NH (US); Hanh Kim Le, Austin, TX (US)

Correspondence Address: Robert H. Frantz, P.O. Box 23324, Oklahoma City, OK, 73123-2334, US

(73) Assignee: International Business Machines Corporation, Armonk, NY (US)

(21) Appl. No.: 09/801,604

(22) Filed: Mar. 8, 2001

(51) Int. Cl. G06F 17/60

(52) U.S. Cl. 705/37

(57) ABSTRACT

A networked computer arrangement through which a manufacturer or service provider may communicate to a bidder or broker information regarding total bid exposure and total commitment to purchase, filtered by type of on-line offer, status of bids, and status of each on-line offer. An on-line bidder may view real-time bidding account information filtered by whether the offer or auction is opened or closed, for all types of auctions or by specific types of auction, and/or by status of bids such as won, beaten, undecided. The invention is particularly well-adapted for use over the Internet, intranets, and extranets, in conjunction with on-line auctions and business-to-business offering systems.

### BACKGROUND OF THE INVENTION

1. Field of the Invention

The present invention relates generally to electronic commerce, to conducting a business-to-business interactive offer and bid collection over a computer network, and to providing bidders and brokers with overview information regarding bids places, bids won, and bids lost so that bidders and brokers may manage their current exposure to purchase in real-time.

2. Description of the Related Art

Prior to the advent of electronic auctioning over computer networks or electronic commerce, auctions were held in a group of gathered bidders with an auctioneer. As shown in FIG. 1, an auction (1) is conducted on behalf of a seller (2) by an auctioneer (4). The auctioneer receives a list of items to be sold and possibly a minimum and/or reserve price for those items. During the auction, a plurality of bidders (6) place bids (5) under the guidance and control of the auctioneer (4). In some cases, multiple bidders (9) may pool (8) their bids, and the pooled bids (7) are submitted as a single bid with a combined quantity to the auctioneer (4).

The auctioneer enforces the rules of the auction, such as minimum bid price and quantities, minimum bid incrementing from the previous bid for a new bid, and time limits for placing bids. Auction bidders are typically qualified as to their ability to complete the purchase should their bid be the winning bid prior to entering the auction room.

Many online auctioning systems such as “priceline.com” have become very popular for individuals and businesses to use to take advantage of auctions at which they cannot be physically present. Such e-commerce auctions or online auctions are usually conducted over a specified period of time of opening and closing for bids, and are typically conducted under one of several well-known sets of rules or models. These common models include “Dutch” auctions, progressive auctions, “Yankee” auctions, single-bid auction, sealed bid auctions, reserve auctions, and hybrids of these types of auctions.

However, most sales offering and bid systems conducted by manufacturers of goods or service providers are conducted under a different set of procedures and processes. Turning to FIG. 2, a typical trader and broker system for offering and accepting bids is shown (20). In such a business-to-business (“B2B”) offering and bidding process (20), a manufacturer or service provider (21) will notify one or more traders (24) of available products or services, quantities, and minimum acceptable bid values (22). The trader then provides offerings (23′) to one or more brokers (25), to which the brokers may respond with bids (23).

In some cases, bids may be accepted for either partial lots or whole lots of offered products. These offerings (23′) and the corresponding bids (23) are collected by the trader, and the trader (24) makes a decision of which bids to accept. The traders (24) subsequently respond to the manufacturer or service provider (21) with actual orders or purchases (22).

Although the B2B offering and bid acceptance process may be conducted similarly to an auction, it is not an auction in the strict sense in that the order fulfillment, or bid acceptance, process is conducted usually by the trader at his discretion. For example, under a typical auction process, the highest qualified bidder may be defined as the bid winner. However, in a B2B offering and bid collection system, the trader may favor the second or third highest bid over the highest bid for the fact that the broker placing the second or third highest bid has preferred business arrangements, such as a longer history of purchasing from the trader or a history of larger volume purchases with the trader.

Brokers typically buy on speculation, and sell to end users. Brokers may sell to multiple retailers of products or services, or they may represent a single large retailer of a product or service.

Traders are typically commissioned sales professionals, and the structure of their commissions may vary depending on the quantities and the commodities or category of products being sold.

According to industry terminology, “Reseller Master Agreements” usually govern what a broker may purchase, which are enforced by the individual traders. For example, a particular broker may only have rights to purchase given commodities or categories of products within a certain geographical zone or region as defined by his Reseller Master Agreement with the manufacturer or service provider.

Further, traders may be restricted to handling specific commodities or categories of products and also may be restricted to certain localities. For example, a trader may specialize in furniture from a particular manufacturer, and may not be authorized to handle carpets or other textiles from the same manufacturer. This trader's expertise in furniture allows him to focus his knowledge and understanding into the market place for furniture. A trader may also be restricted as to the locality or geographical region in which his brokers may purchase gods, such as Europe, North America, or even more specific such as a particular state or city.

Thus, a particular broker may receive offers from multiple traders who represent a particular manufacturer or service provider. For example, a broker that represents a chain of computer stores may receive computer memory offers from a first broker, software upgrade offers from a second broker, and peripheral offers from yet a third broker, all of whom represent the same manufacturer. In response, this broker may bid for products or services in different categories, and must submit those bids to different traders based on the traders' commodities or categories of products that each trader handles.

As such, it is desirable not to present information to the traders or brokers which is irrelevant to the products or commodities for which they are entitled to purchase under their Reseller Master Agreement. For example, certain brokers and traders may be associated with geographical regions which are not allowed to receive certain products or services from the manufacturer because of regulatory or export controls. Additionally, certain contractual restrictions between the manufacturer and the trader or other traders and other brokers may establish territorial boundaries regarding products and services handled by the brokers and traders. Further, even though a broker may be entitled to receive offers for a particular product or service, it may not be desirable to indicate to that broker the total quantity available from the manufacturer, as having this knowledge may not encourage the broker to place his highest possible bid for the product or service.

The related patent application disclosed an on-line business-to-business offer system which is suitable for presenting information to bidders and brokers for products and services on which they are entitled to bid.

As a bidder or broker places bids on multiple items, there is usually a period of time during which the bidder has several outstanding bids in offerings or auctions which have not been closed. During this time, if all of a bidder's bids are accepted (e.g. they “win” the bidding process), the bidder is obligated to conclude purchase of all items on which bids were placed. So, in broker parlance, the bidder's maximum “exposure” (potential for obligated purchases) is the sum of all outstanding bids. So, the first problem in the art presents itself as the inability of a bidder who has multiple outstanding bids to easily and quickly determine his current maximum “exposure” so that the bidder can decide to place additional bids or wait for some of the current auctions to close.

As auctions close and the broker's bids are accepted (“won”) or rejected (“lost”), the broker's total exposure to potential purchases changes as well as the broker's total purchase commitment. So, as an a bid is won, the value of the bid adds to the broker's total commitment to purchase offered items. And, as a bid is lost, the value of the lost bid is no longer part of the broker's total “exposure” to potential purchase.

So, a more complex problem presented in the current online technologies is that it may be very difficult, if not impossible, for a broker or bidder to keep track in real-time of his total purchase commitment and total exposure, as auctions and offer periods close at different times and dates.

It is necessary, however, for a broker to know these factors as he or she places new bids. A broker who over bids his or her capability to purchase all the items on which the broker has bid may find himself or herself in default of an obligation to purchase items. A broker who under bids his or her ability to purchase items may unnecessarily miss opportunities to bid on newly-offered items.

Therefore, there is a need in the art for a system and method which quickly and easily presents on-line bidding information related to a bidder's real-time exposure to obligation to purchase and actual obligation to purchase offered so that the bidder may manage his or her bidding account and business more effectively.

### BRIEF DESCRIPTION OF THE DRAWINGS

The following detailed description when taken in conjunction with the figures presented herein provide a complete disclosure of the invention.

FIG. 1 discloses the well-known arrangement of sellers, auctioneers, and bidders.

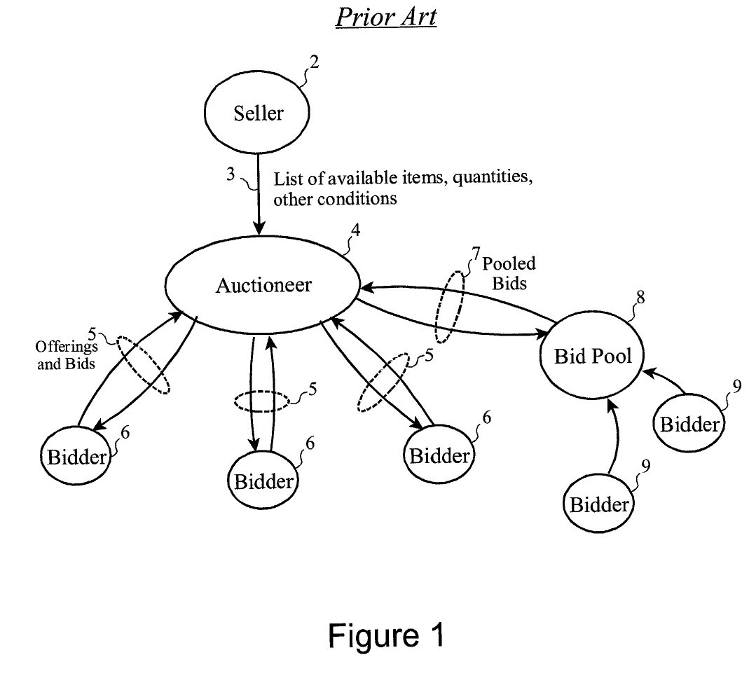

FIG. 2 shows the common business arrangement between manufacturers, service providers, traders, and brokers.

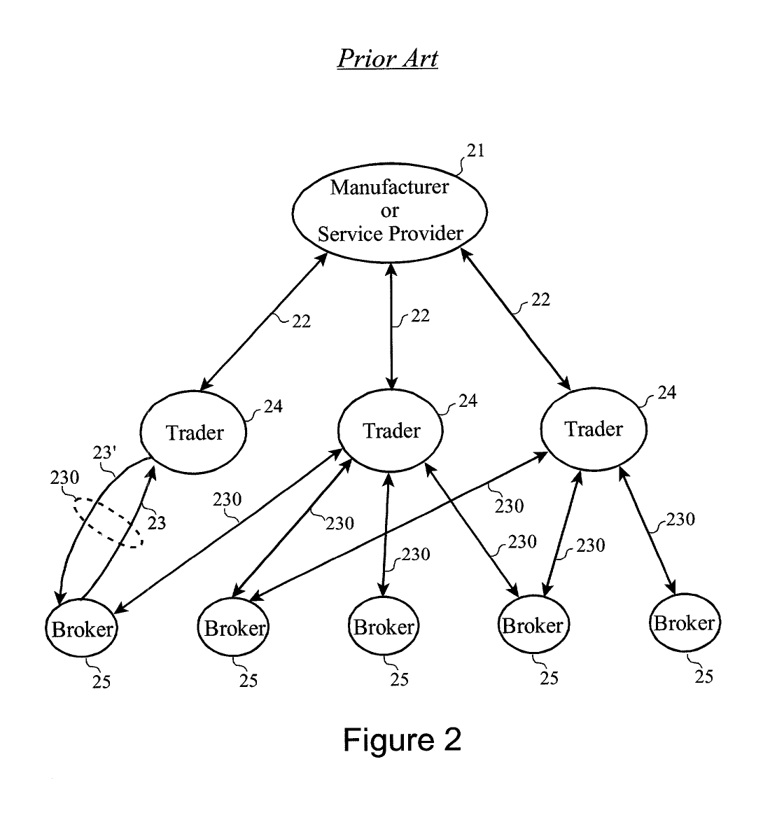

FIG. 3 shows the user interface presented to the bidder or broker of the preferred embodiment.

FIG. 4 illustrates the logical flow of the process of managing broker offer factors and presenting those factors to brokers and bidders.

FIG. 5 shows a generalized system architecture of the invention.

FIG. 6 sets forth the preferred embodiment of the system of the invention.

### SUMMARY OF THE INVENTION

In order to address the aforementioned needs in the art, the present invention provides a networked computer arrangement and method in which a manufacturer or service provider may communicate to a bidder or broker information regarding total bid exposure and total commitment to purchase, filtered by type of on-line offer, status of bids, and status of each on-line offer. A bidder may easily and quickly view real-time bidding account information filtered by whether the offer or auction is opened or closed, for all types of auctions or by specific types of auction, and/or by status of bids such as won, beaten, undecided. Information presented is crucial to the effective management of a bidding account in order to maximize a bidder's participation in on-line offers and auctions while avoiding over commitment to purchase item with winning bids.

The system and method are particularly well-adapted for use over the Internet, intranets, and extranets, in conjunction with on-line auctions and business-to-business offering systems, by allowing common computer web browsers, network terminals, and wireless web browsers to be used as the offering and bidding consoles to which the management information is delivered.

### DETAILED DESCRIPTION OF THE INVENTION

It will be recognized by those skilled in the art that certain combinations and integration of the features presented herein may be made without departing from the spirit and scope of the invention. Further, it will be recognized that many of the architectural details disclosed herein are disclosed under the inventor's preferred embodiment in order to enhance the robustness and reliability of the invention, but these details may not be necessary to realize the fundamental functionality of the invention.

Throughout the disclosure given herein and the following claims, the term “broker” is used to describe a bidding party or bidder, and the term “trader” is used to describe a party who conducts the process of promoting offers to bidding parties. This is nearly analogous to bidder and auctioneer in the context of a traditional auction, respectively, although the offering and bidding process provided by the invention may be used to conduct business-to-business offers as well as traditional types of auctions.

Even though the following description of the preferred embodiment is given relative to implementation as a feature of function in a specific interactive offering system, it will be recognized by those skilled in the art that the invention may be equally well implemented as a feature or function in conjunction with any on-line auction or offering system.

General Description of the Interactive Offering System

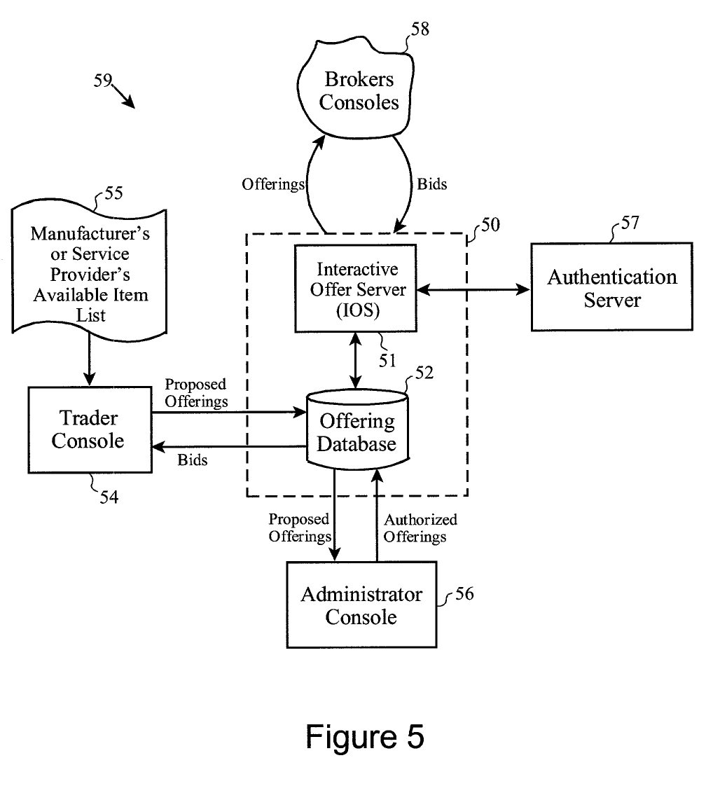

The following general description of the Interactive Offering System (“IOS”) is summarized from the related application. Turning to FIG. 5 in which the general architecture of the system of the preferred embodiment of the invention is shown, the Interactive Offer Server (“IOS”) (51) is associated with an offering database (52). The offering system (50) is included in the larger architecture (59) which includes the brokers' consoles (58), the administrator console (56), and the traders' consoles (54). All consoles and the interactive offering server may communicate either as an integrated package within one computer system, or as separate computer systems integrated and communicating over a computer network such as the Internet.

In the general architecture of FIG. 5, the manufacturer or service provider's goods availability list (55) is received by the trader consoles (54). The trader then creates proposed offerings for bidders or brokers. The proposed offerings are input into the offering database (52), which are then retrieved by the administrator using his administrator console (56).

The administrator authorizes the proposed offerings and makes a note or change in the offering database records to indicate such authorization.

During the open bidding process, the brokers or bidders may use their consoles, such as web browser personal computers (58), to retrieve their offerings, and to submit bids via the IOS (51). When a broker makes contact with the interactive offering server, his identity is first verified by an Authentication Server (57), according to the preferred embodiment.

In response to the broker's request for products or services offerings, the IOS queries the offering database (52) and presents the broker with offerings which contain items to which he or she is entitled to bid. An authentication server (57) is included in the preferred embodiment so as to allow the interactive offering server to authenticate the broker prior to presenting any offerings to the broker. As such, the general architecture (59) as shown in FIG. 5 provides each broker with one or more offerings which have been authorized.

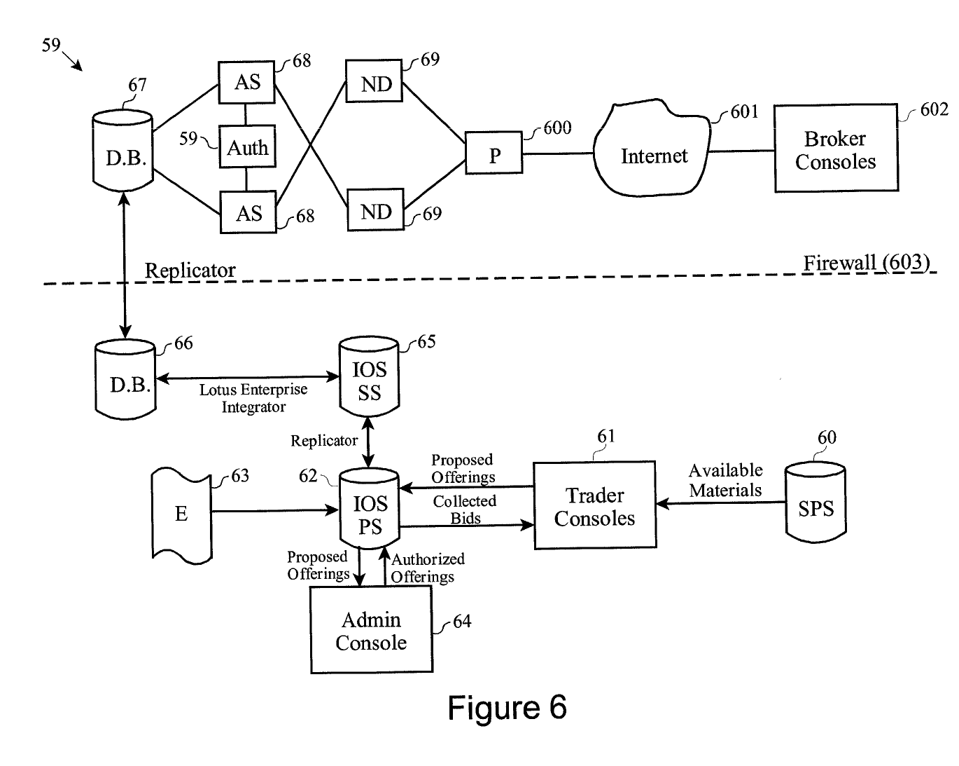

Turning to FIG. 6, the detailed organization of the system according to the preferred embodiment is shown. A sales preparation system (60) comprising an IBM Lotus Notes system provides available materials list to the traders via their trader consoles (61), which are networked personal computers also running Lotus Notes applications. These available materials lists could alternatively be simple text file lists or spreadsheets, as well as database records. Alternatively, the trader consoles (61) may be dedicated computer consoles, web browser computers, or other appropriate computer user interface devices such as wireless web browsers.

Using a trader console, a trader then filters the available materials list for each broker or bidder to prepare proposed broker offerings to be stored in the IOS production server (62).

An administrator may use an administrator's console (64) to query the database of the IOS production server (62) to retrieve and review a trader's proposed offerings. He may authorize all or some of the proposed offerings, and place those authorized offerings in the IOS database for replication to the IOS staging server (65).

Posting of the authorized offerings to the IOS staging server (65) is preferably done by a Lotus Notes replicator function. As both the IOS production server (62) and staging server (65) are based on IBM Lotus Notes systems in the preferred embodiment, the replicator is a natural function of Lotus Notes which is easily incorporated and maintained. An IBM Lotus Enterprise Integrator (“LEI”), formerly known as “Notes Pump”, then prepares a DB2 database file (66) from the IOS staging server (65).

Further according to the preferred embodiment, all of these previously described systems and components and processes are executed and placed behind a protective data “fire wall” (603) for system security. The posted available offerings for the brokers are replicated to another database outside the firewall, preferably in a DB2 format (67) again. This “outside” database is available for query by at least one application server (68).

Also according to the preferred embodiment, a clustered pair of application servers (68) are used to query the outside database (67) for available offerings for brokers. The application servers are provided requests from the brokers via network dispatchers (69). The network dispatchers (69) receive broker requests for offerings by a proxy server (600). Thus, the brokers may use their broker consoles (602), such as web browser personal computers or wireless web browsers, to query the outside database (67) via a computer network (601) such as the Internet.

The network dispatchers provide balanced loading to the application servers (68), and they provide for redirection of requests to one of the application servers should the other application server experience a failure. After the brokers receive their offerings of entitled materials or services on which they may bid via their broker consoles (602), they may post bids which are stored in the outside database (67).

The posted bids are then replicated from the outside database (67) to the inside database (66) behind the firewall. The LEI then moves those bids, converts them from DB2 format to Lotus Notes format, and stores them in the IOS staging server (65). These bids are farther replicated from the Lotus Notes format in the IOS staging server (65) to the IOS production server (62), where they then may be retrieved and reviewed by the traders using the trader consoles (61). Thus, the entire offering-to-bid process is completed. The traders may then choose to accept or reject each posted bid.

According to the preferred embodiment, the application servers (68) are web server hardware platforms, such as IBM RS6000 computers running the IBM AIX operating system, accompanied by the IBM WebSphere product. Java servlets are used to interact with the broker console computers (602), which could be alternately realized in such technology as Microsoft's Active Server Pages or Java server pages.

Further according to the preferred embodiment, the application servers are provided with communications capability to an authentication server (57) which may include lists of brokers and passwords against which broker log-in attempts may be validated.

Preparation and Presentation of Bidding Account Status Information

The invention is preferably realized as a script or program executed by the IOS server (65). The script or program of the invention is preferably a Java servlet, but may be any suitable language compatible with alternate database platform choices.

The IOS server (65) accesses the database containing the received bids. As the trader in charge of a particular offering session or auction accepts “winning bids” in the particular offering session, the winning bids are marked in the database as “won”, and all other bids to that offering session are marked as “lost”. Also, at that time, the offering session or auction status is changed from “open” to “closed”.

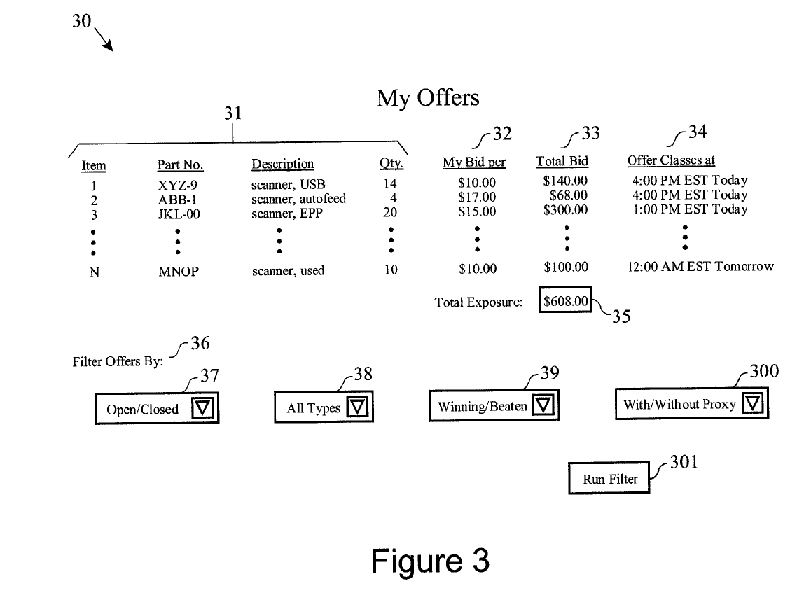

Turning to FIG. 3, the preferred embodiment of the “MyOffers” document (30) delivered to the broker's or bidder's console is shown. As the preferred bidder console is a web browser computer, the preferred format of the MyOffers document (30) is an HTML document. The specific format of the MyOffers document can be varied to be compatible with alternate bidder consoles, as will be recognized by those skilled in the art.

The MyOffers document (30) preferably contains a table object having several rows, each row representing the highest bid from the bidder for a particular material, and having several columns:

Item descriptive information (31) which may include item numbers, part numbers, text descriptions, and available quantities of the items for each bid;

the current bid per item (32);

a total bid (33) value calculated by multiplying the available quantity by the current bid per item (32); and

offer closing information (34) such as the time and/or date the offer or auction will be closed.

The MyOffers document (30) is provided with a plurality of filtering options, preferably in the form of user-selectable drop down lists, but alternatively in the form of check boxes or other well-known user interface icons, the filtering options including:

offering status (37), such as “open”, “closed” and “open/closed”, wherein selection of the “open/closed” option filters for all offerings regardless of open/close status;

type of offering (38), such as single-bid, interactive, progressive, Dutch, Yankee, etc., or “All Types”;

bid status (39) including “winning”, “beaten”, or “winning/beaten”, wherein “winning/beaten” filters for all bids regardless of whether they have been accepted (won) or rejected (beaten); and

proxy state (300) such as “with proxy”, “without proxy”, and “with/without proxy”.

A bid with a proxy is a bid which is automatically incremented from a starting point to a maximum bid value, in order to beat competitive bids at the lowest possible winning bid value. For example, a bid of $25.00 may be submitted with proxy to $50.00 in a particular auction. As opposing bids are placed above $25.00, the bid with proxy is increased to beat the next higher bid by an incremental amount, say $1.00. So, an opposing bid of $28.50 would result in the bid with proxy being increased to $29.50. Once the opposing bids reach the proxy maximum, the bid with proxy does not continue to automatically increase beyond the proxy maximum. So, for a bidder with outstanding bids with proxy, there are two types of exposure that are interesting: (a) the current value of the bids with proxy and (b) the maximum value of the bids with proxy.

The “run filter” button (301) on the MyOffers document (30) submits a request to the IOS server to re-filter the presented information based upon the current filter settings.

The MyOffers document (30) is shows the total exposure value (35), preferably below the last entry in the total bid column (33), which is found by adding all of the individual total bid values (33). Since the information presented in the table is the results of the filter settings (36), the total exposure value (35) is the sum of the total bid values which meet the filter criteria. It may represents one of several interesting factors, depending on the filter settings, such as:

actual total commitment found by filtering on closed offerings and winning bids;

current exposure by filtering on open/closed offerings, winning/beaten bid status, without proxy; and

maximum possible exposure by filtering on open/closed offerings.

Using the offering type filter setting can generate interesting subtotals of these totals, such as the maximum possible exposure of all bids in single-bid offerings only, or such as actual total commitment in Dutch auctions.

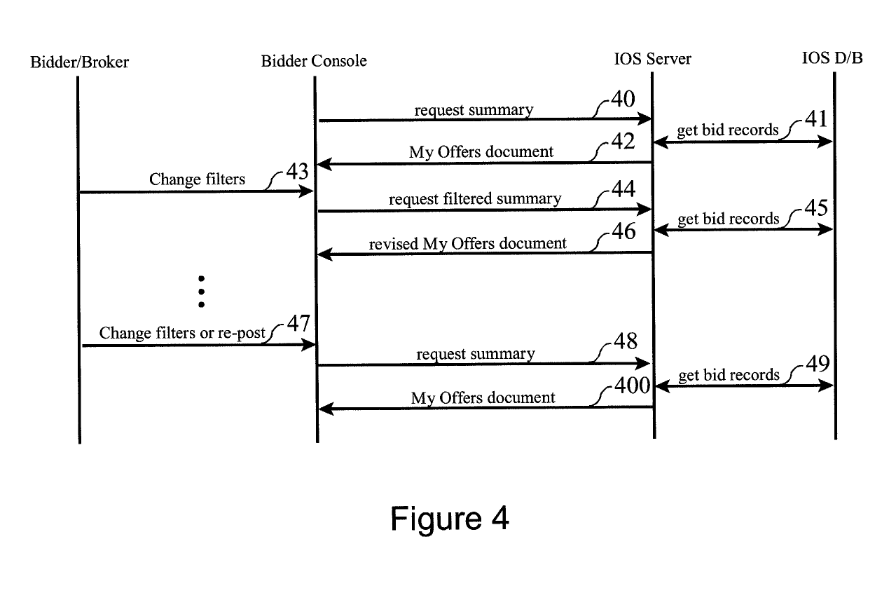

Turning to FIG. 4, the process of providing the MyOffers document to the bidder or broker is shown. Initially, the broker may request (40) a bidding account summary from a bidding console. In the preferred embodiment, the filter settings for this request are set to default values, such as “open/closed”, “All Types”, “winning/beaten”, and “with/without proxy”.

The IOS Server receives the initial request, queries (41) the IOS Database to get the records that match the request filter criteria. Then, the IOS Server prepares the MyOffers document and transmits (42) to the bidder console. The bidder may subsequently change the filter settings (43), click the “run filter” button to generate (44) a new request for account summary with new filter settings, which causes the IOS server to query (45) the IOS Database for matching records, and to prepare and return (46) a revised MyOffers document containing only the bids that match the filter criteria.

At any time in the future, the bidder may change the filter settings (47), and request (48) and receive (400) updated MyOffer documents.

In an enhanced embodiment, the MyOffers document may be provided with an automatic, timer-based re-posting function such as an HTML automatic re-post command, in order to have the MyOffers document automatically update without specific requests from the bidder.

It will be understood by those skilled in the art and from the foregoing description that various modifications and changes may be made in the preferred embodiment of the present invention without departing from its spirit and scope, such as use of or integration to other on-line offering and auction systems, use of alternate bidder consoles and document formats, and implementation using alternate programming languages and methodologies. It is intended that this description is for purposes of illustration only and should not be construed in a limiting sense. The scope of this invention should be defined by the following claims.

What is claimed is:

1. A method for preparing and presenting bid account information to electronic auction and offering session participants, comprising the steps of:
providing a first user interface display to a session participant having a first set of information regarding pending bids, accepted bids, and rejected bids, with summaries of total values of said bids, said first user interface display having a plurality of user-selectable filter options;
receiving a set of filter options as selected by a user; and
providing a subsequent user interface display having a subsequent set of information regarding pending bids, accepted bids, rejected bids, and summary total values of said bids in the subsequent set, said bids presented in said subsequent set matching said filter options.

2. The method as set forth in claim 1 wherein said steps of providing first user interface display and providing subsequent user interface displays comprise providing web documents.

3. The method as set forth in claim 1 wherein said first user interface display and said subsequent user interface display are provided on a web browsing device.

4. The method as set forth in claim 1 wherein said filter options include an open/closed option for filtering on bids in sessions which are still open, bids in sessions which have closed, and any bids in any session regardless of auction or offering closing.

5. The method as set forth in claim 1 wherein said filter options include a session type option for filtering on bids in a specific type or types of session.

6. The method as set forth in claim 1 wherein said filter options include a winning/beaten option for filtering on bids which are winning bids, on bids which are beaten, or all bids regardless of winning/beaten status.

7. The method as set forth in claim 1 wherein said filter options include a with/without proxy option for filtering on bids which have proxies, which have no proxy, or all bids regardless of proxy status.

8. A computer-readable medium having stored thereon program code for preparing and presenting bid account information to electronic auction and offering session participants, said program code when executed by a session server computer and a bidder console computer causing the computers to perform the steps of:
providing a first user interface display to a session participant having a first set of information regarding pending bids, accepted bids, and rejected bids, with summaries of total values of said bids, said first user interface display having a plurality of user-selectable filter options;
receiving a set of filter options as selected by a user; and
providing a subsequent user interface display having a subsequent set of information regarding pending bids, accepted bids, rejected bids, and summary total values of said bids in the subsequent set, said bids presented in said subsequent set matching said filter options.

9. The computer-readable medium as set forth in claim 8 wherein said program code for providing a first user interface display and said subsequent user interface displays comprises program code for providing web documents.

10. The computer-readable medium as set forth in claim 8 wherein said program code for providing a first user interface display and subsequent user interface displays is adapted to provided displays to a web browsing device.

11. The computer-readable medium as set forth in claim 8 wherein said program code for providing filter options includes program code for providing an open/closed option for filtering on bids in sessions which are still open, bids in sessions which have closed, and any bids in any session regardless of auction or offering closing.

12. The computer-readable medium as set forth in claim 8 wherein said program code for providing filter options includes program code for providing a session type option for filtering on bids in a specific type or types of session.

13. The computer-readable medium as set forth in claim 8 wherein said program code for providing filter options includes program code for providing a winning/beaten option for filtering on bids which are winning bids, on bids which are beaten, or all bids regardless of winning/beaten status.

14. The computer-readable medium as set forth in claim 8 wherein said program code for providing filter options includes program code for providing a with/without proxy option for filtering on bids which have proxies, which have no proxy, or all bids regardless of proxy status.

15. An online offering system for preparing and presenting bid account information to electronic auction and offering session participants, said offering system comprising:
a first user interface display having a first set of information regarding pending bids, accepted bids, and rejected bids, with summaries of total values of said bids, said first user interface display having a plurality of user-selectable filter options;
a bid filter for sorting and selecting bids which match user-selected filter options; and
at least one subsequent user interface display having a subsequent set of information regarding pending bids, accepted bids, rejected bids, and summary total values of said bids in the subsequent set, said bids presented in said subsequent set containing said sorted and selected bids.

16. The system as set forth in claim 15 wherein said first user interface display and said subsequent user interface display comprise web documents.

17. The system as set forth in claim 15 wherein said first user interface display and said subsequent user interface display are adapted to be displayed on a web browsing device.

18. The system as set forth in claim 15 wherein said filter options include an open/closed option for filtering on bids in sessions which are still open, bids in sessions which have closed, and any bids in any session regardless of auction or offering closing.

19. The system as set forth in claim 15 wherein said filter options include a session type option for filtering on bids in a specific type or types of session.

20. The system as set forth in claim 15 wherein said filter options include a winning/beaten option for filtering on bids which are winning bids, on bids which are beaten, or all bids regardless of winning/beaten status.

21. The system as set forth in claim 15 wherein said filter options include a with/without proxy option for filtering on bids which have proxies, which have no proxy, or all bids regardless of proxy status.
